(19) United States
(12) Patent Application Publication
(10) Pub. No.: US 2013/0173713 A1
(43) Pub. Date: Jul. 4, 2013

(54) SECURING COMMUNICATIONS AMONG FRIENDS WITH USER-WEARABLE MEMENTOS

(71) Applicants: Eric David Rich Anderson, Beaverton, OR (US); Kavan Saffa Bahrami, Portland, OR (US); Tracie Lee Anderson, Beaverton, OR (US); Elliot Michael, Portland, OR (US)

(72) Inventors: Eric David Rich Anderson, Beaverton, OR (US); Kavan Saffa Bahrami, Portland, OR (US); Tracie Lee Anderson, Beaverton, OR (US); Elliot Michael, Portland, OR (US)

(21) Appl. No.: 13/667,855

(22) Filed: Nov. 2, 2012

Related U.S. Application Data
(60) Provisional application No. 61/582,487, filed on Jan. 2, 2012.

(51) Int. Cl. H04L 29/08

(52) U.S. Cl. CPC H04L 67/10
USPC 709/205

(57) ABSTRACT

Systems and methods for securing communication between users possessing user-wearable mementos are provided. One example computing system includes a data subsystem holding instructions executable by a processing subsystem. The example instructions are configured to assign a set identifier to a set of user-wearable mementos set that uniquely distinguishes the set from any other set and to encode the set identifier within a design for the set in response to receipt of a request to obtain the set. The instructions are also configured to provide access to a user communication interface in response to an access request for a set profile associated with the set, the access request including the set identifier as obtained from a particular user-wearable memento bearing the design.

### RELATED APPLICATIONS

This application claims the benefit of U.S. Provisional Application No. 61/582,487 entitled COMPUTERIZED DESIGN, TRADE, AND TRACK WEBSITE AND ASSOCIATED PHOTO-PRINTED APPAREL ITEM, filed on Jan. 2, 2012, the disclosure of which is incorporated by reference in its entirety for all purposes.

### BACKGROUND

Creating a tangible sense of connection with friends in an online network can be hard. While a social network service may allow individuals to share with one another, such sharing usually requires online service access. Moreover, maintaining different sets of friends via a such services may be labor-intensive, potentially requiring a user to manage access settings, friend lists, and so on, with the potential danger of exposing private information to an undesired audience lurking behind shifting levels of friendship. Faced with such burdens, it may be difficult for one person to feel a personal sense of connection like that experienced in a face-to-face relationship.

### BRIEF DESCRIPTION OF THE DRAWINGS

FIG. 1 schematically shows an example secure communication system according to an embodiment of the present disclosure.

FIG. 2 schematically shows an example user-wearable memento according to an embodiment of the present disclosure.

FIG. 3 schematically shows an example user-wearable memento according to another embodiment of the present disclosure.

FIG. 4 schematically shows an example set of user-wearable mementos according to an embodiment of the present disclosure.

FIG. 5 shows a flowchart for an example method of obtaining a set of user-wearable mementos according to an embodiment of the present disclosure.

FIG. 6 schematically shows an embodiment of a login interface for use with an embodiment of a secure communication system according to the present disclosure.

FIG. 7 schematically shows an embodiment of a design interface for use with an embodiment of a secure communication system according to the present disclosure.

FIG. 8 schematically shows an embodiment of a browser interface for use with an embodiment of a secure communication system according to the present disclosure.

FIG. 9 schematically shows an embodiment of a designer profile interface for use with an embodiment of a secure communication system according to the present disclosure.

FIG. 10 schematically shows an embodiment of a cart checkout interface for use with an embodiment of a secure communication system according to the present disclosure.

FIG. 11 shows a flowchart for an example method of fabricating a set of user-wearable mementos according to an embodiment of the present disclosure.

FIG. 12 shows a flowchart for an example method of accessing and updating a set profile using a secure communication system according to an embodiment of the present disclosure.

FIG. 13 schematically shows an embodiment of a user communication interface for use with an embodiment of a secure communication system according to the present disclosure.

FIG. 14 shows an embodiment of a top side of an example user-wearable memento according to the present disclosure.

FIG. 15 shows another embodiment of a top side of an example user-wearable memento according to the present disclosure.

FIG. 16 shows another embodiment of a top side of an example user-wearable memento according to the present disclosure.

FIG. 17 shows another embodiment of a top side of an example user-wearable memento according to the present disclosure.

FIG. 18 shows another embodiment of a top side of an example user-wearable memento according to the present disclosure.

FIG. 19 shows another embodiment of a top side of an example user-wearable memento according to the present disclosure.

FIG. 20 shows another embodiment of a top side of an example user-wearable memento according to the present disclosure.

FIG. 21 shows another embodiment of a top side of an example user-wearable memento according to the present disclosure.

FIG. 22 shows an embodiment of a bottom side of the user-wearable mementos of FIGS. 14-21 with certain features shown in broken lines.

FIG. 23 shows an edge elevation of the user-wearable mementos of FIGS. 14-22, with certain features shown in broken lines.

### DETAILED DESCRIPTION

Keeping track of virtual relationships in the physical world can be difficult. While social network services may help forge and maintain friendships in an online setting, it can be difficult to meet online friends in person. Some previous approaches to forming friendships online rely on techniques that track an item, such as tracking currency by serial number or tracking some other uniquely identifiable item, as the item passes from person to person in daily use. Because such approaches are targeted at friend discovery, they may rely on making many random encounters in the hope of finding a few new friends. Consequently, such approaches may include frequent, public information exchanges.

The public nature of such approaches may be unappealing to some who wish to keep track of friends on a more personal level. While a potentially limitless supply of viewers may be helpful in a friend discovery context, maintaining existing relationships may be difficult, especially when friends wish to share private information. Accordingly, the various embodiments described herein relate to methods and hardware that facilitate secure communication between users having access to a set of user-wearable mementos. One example embodiment includes a computing system comprising a data subsystem holding instructions executable by a processing subsystem. The example instructions are configured to assign a set identifier to a set of user-wearable mementos that uniquely distinguishes the set from any other set, and to encode the set identifier within a design for the set. The assignment and encoding of the set identifier may be performed in response to receipt of a request to obtain the set of mementos. The instructions are also configured to provide access to a user communication interface in response to an access request for a set profile associated with the set, the access request including the set identifier as obtained from a particular user-wearable memento bearing the design.

Consequently, the digitally-linked user-wearable mementos enable users to securely communicate with one another via digital networks (e.g., “over the Internet,” or “online”). For example, a user having access to one of the user-wearable mementos in a set is able to communicate with another user having access to a user-wearable memento in the same set. In turn, the users within that set (“user set”) may be able to communicate privately, enjoying a dimension of their friendship that may otherwise be inhibited by non-private online communication.

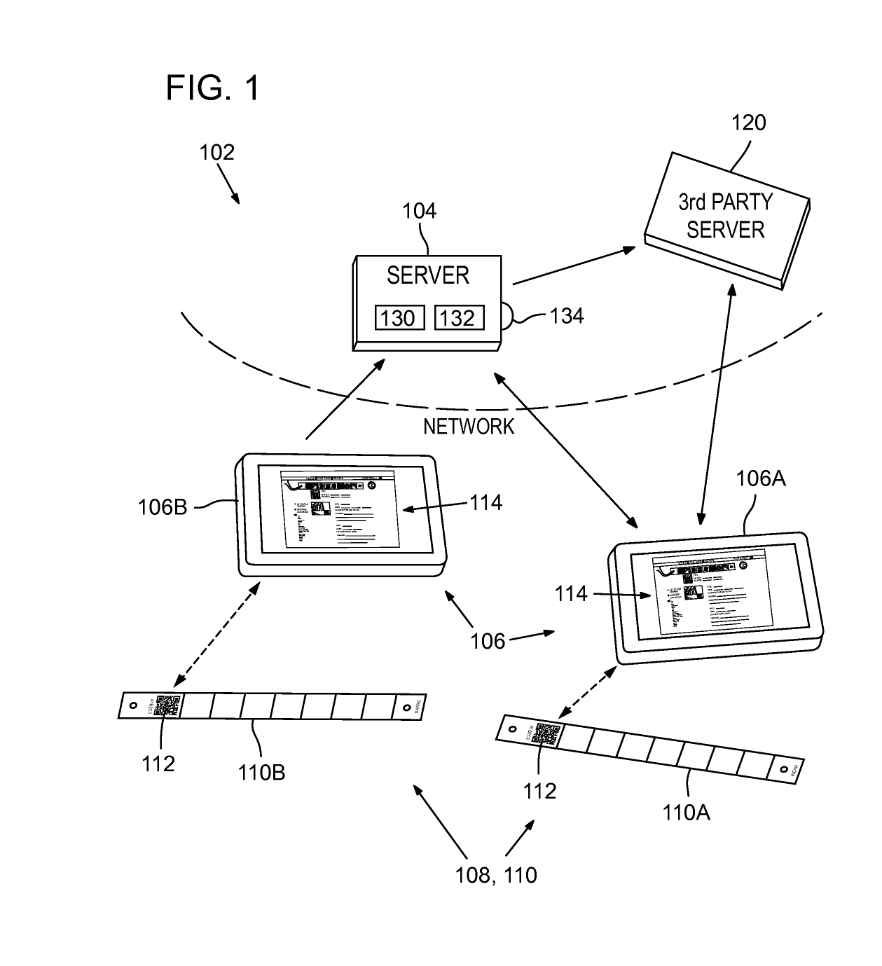

FIG. 1 schematically shows an operating environment for an embodiment of a secure communication system 102. Secure communication system 102 includes a server computing device 104 in communication with a plurality of client computing devices 106, shown individually as 106A and 1068 in FIG. 1, via a network. Communication among these computing devices is secured using a set 108 of user-wearable mementos 110, shown individually as 110A and 1108 in FIG. In some embodiments, a user may create a memento design for user-wearable mementos 110. The memento design may include expressions of the user's culture, interest, and creativity. Once produced, the mementos in the set may make an online social experience tangible, potentially facilitating face-to-face communication between individuals of an online community in the real world. Put another way, set 108 of user-wearable mementos 110 may become a real-world souvenir of an online experience, and to subsequently create an online record or memento of a real-world encounter.

As used herein, a set 108 of user-wearable mementos 110 refers to a plurality of user-wearable mementos 110, each user-wearable memento within set 108 being identified by a set identifier that encodes identifying information for a set 108 of user-wearable mementos 110. A set identifier for a given set distinguishes that set from any other set. Further, the set identifier for a given set is the same for all user-wearable mementos 110 in that set. Because a given set identifier uniquely identifies a set associated with that set identifier, only users having access to a user-wearable memento 110 within that set will have access to information secured using the set identifier.

In the embodiment shown in FIG. 1, client device 106A obtains a set identifier from a code 112 included on user-wearable memento 110A. Once the set identifier is obtained, client computing device 106A uses the set identifier to request access to a user communication interface associated with set 108. In turn, server computing device 104 verifies the set identifier and grants access to private information shared among the users in the user set via the user communication interface.

In the embodiment shown in FIG. 1, client device 106A displays an instance of a user communication interface 114. Likewise, client device 106B graphically displays another instance of user communication interface 114. Thus, secure communication system 102 permits users within the user set to explore their relationships with one another by posting messages, posting and tracking user locations, geotagging, chatting, sharing ideas, playing games with one another, and/or collaborating with one another in an online environment. For example, users in a user set may play an achievement-based game with one another using user-wearable mementos 110, competing for greatest distance traveled, most location check-ins, most activities accomplished, and so on. In turn, the gameplay may help the users to strengthen and explore new dimensions of their relationships with one another.

FIG. 1 also depicts server computing device 104 and one or more of client computing devices 106, 106A as being in communication with a third-party server 120. In some embodiments, access to third-party server 120 may be secured using a set 108 of user-wearable mementos 110. For example, users may access third-party server 120 with user-wearable memento 110A. Thus, user-wearable memento 110A may secure access to outside services, such as social networks, photo-sharing sites, commercial services, and so on. In one scenario, a user may access the user's social network account using user-wearable memento 110A via an association formed between user-wearable memento 110A, the user, and the user's social network account so that the user is presented with an interface for the user's social network account upon scanning user-wearable memento 110A. In another scenario, a user may access a commercial website offering special promotions and/or exclusive content using a code included in the user-wearable memento 110. For example, a user may be presented with a commercial website upon scanning a portion of user-wearable memento 110, such as code 112 or a design element included in user-wearable memento 110, such as a design or logo associated with the commercial website. In yet another scenario, a user may access a secure payment system via the user-wearable memento 110. For example, a user wishing to pay for goods or services may scan user-wearable memento 110A. In turn, a third party payment service may transfer funds from the user's bank or credit account to an account belonging to a merchant or service provider involved in the user's transaction.

As well as securing access to user communication interface 114, user-wearable mementos 110 may be highly personalized articles manifesting a designer's creative expression. As used herein, a designer refers to anyone who selects a design for a set of user-wearable mementos. In some scenarios, one designer may select a portion of or a complete design created by another. For example, a person choosing a design for a set of user-wearable mementos may elect to include another's design, alone or in combination with another design, in the user-selected memento design. In other scenarios a designer may create a design alone. The product of that person's design selection is a user-selected design. The memento design refers to the design for, or as applied to, an individual user-wearable memento, which includes the user-selected design and may include one or more additional design elements. The set design refers to the design for, or as applied to a set of user-wearable mementos, which includes the memento design and may include one or more additional design elements.

For example, user-wearable mementos 110 may, in some embodiments, feature one or more photographs, symbols, text, and artwork created by and/or selected by the designer. Further, any suitable article wearable by a user or someone a user cares for may be a user-wearable memento 110. Non-limiting examples of user-wearable mementos 110 include friendship bracelets, apparel, fashion accessories, and so on. Once fabricated, user-wearable mementos 110 may be traded or shared with others and tracked online using user communication interface 114. Thus, user-wearable mementos 110 may help people make friends and strengthen connections in-person and online.

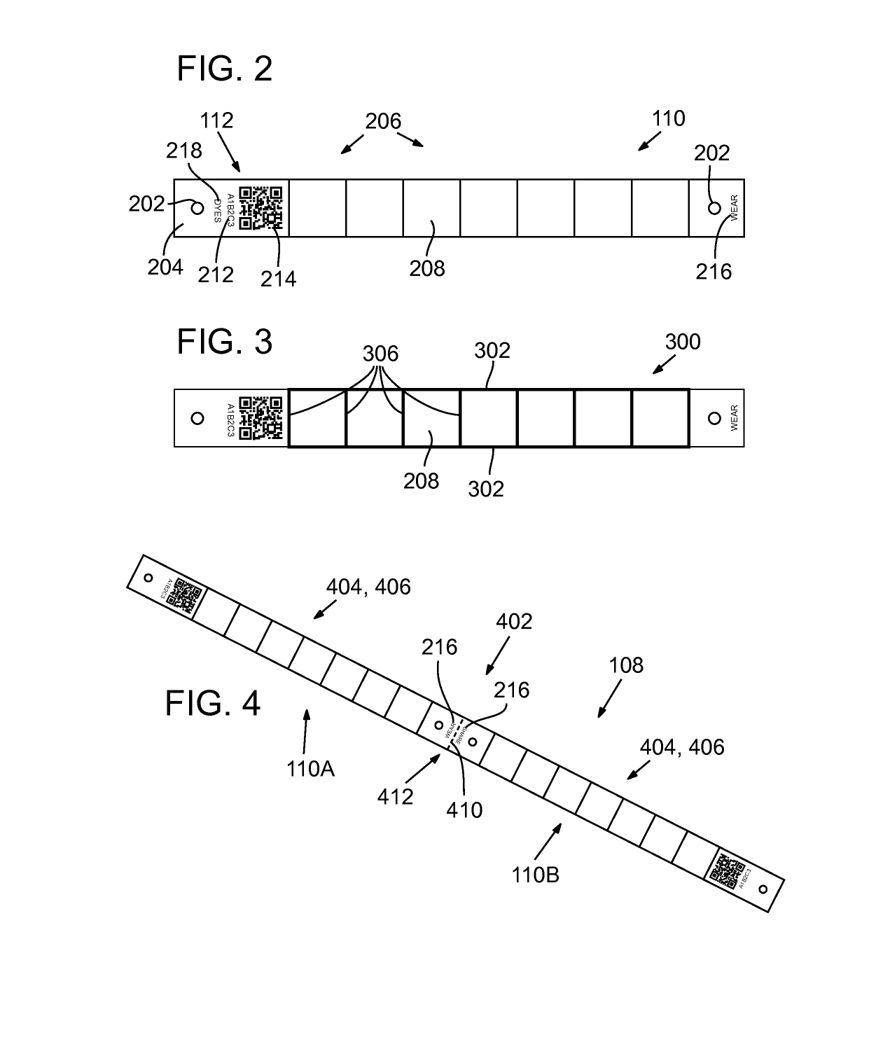

FIG. 2 illustrates an embodiment of a user-wearable memento 110. In the embodiment shown in FIG. 2, user-wearable memento 110 includes a design presentation surface 204. While shown as a flat strip in FIG. 2, user-wearable memento 110 may be formed into a friendship bracelet by bending design presentation surface 204 so that a selected pair of attachment locations 202 may be joined.

Design presentation surface 204 acts as a support and background material for a user-selected design that may be applied to or displayed by user-wearable memento 110. Any suitable design presentation surface 204 may be employed without departing from the present disclosure. In some embodiments, design presentation surface 204 may include a printable surface. Non-limiting examples of printable surfaces include textiles, wood materials, leathers, silicones, polymers, and/or paper materials to which a design may be applied by inking (e.g., via screenprinting or lithographic printing), embossing, etching, and so on.

In some embodiments, design presentation surface 204 may include a suitable display surface adapted to display a design using electrophoretic ink (e ink), light emitting diodes (LED), or other display suitable for varying the display of the design. In such embodiments, user-wearable memento 110 may include a suitable power source (e.g., a battery or energy harvester), a suitable communication interface (e.g., a wireless or wired communication interface), a suitable data subsystem (e.g., semiconductor or other suitable memory), and a suitable processing subsystem (e.g., a logic processor or other suitable processor) configured to execute instructions held in the data subsystem and cause the design to be displayed on design presentation surface 204.

In some embodiments, design presentation surface 204 may be treated to enhance durability and/or appearance relative to untreated versions. For example, a protective coating may be applied after design application in some embodiments where a printable surface is included within design presentation surface 204.

Naturally, sizes, shapes, materials, and processing for design presentation surface 204 may vary based on the application in which user-wearable memento 110 is to be employed. In the friendship bracelet introduced above, design presentation surface 204 may include a primed canvas material suitable for ink jet printing, and may have dimensions selected from a non-limiting length range of between 3 and 15 inches and a non-limiting width range of between 0.5 and 4 inches. For example, an individual friendship bracelet may be 5.6 inches long and 0.56 inches wide, within acceptable tolerances. Friendship bracelets sized within this range may fit a wide variety of wrists, arms, ankles, and/or legs belonging to people and/or animals.

User-wearable memento 110 may be secured to a user, to another article, and/or to itself at one or more attachment locations 202. In the embodiment shown in FIG. 2, attachment locations 202 may be used to join respective, opposing ends of design presentation surface 204 into a loop-shaped friendship bracelet using a suitable connector. For example, attachment locations 202 may include one or more holes, some of which may include grommets or other strain-relief structures. In some of such examples, a tie connector (e.g. string) attached to a hole at one or both ends may be used to join the ends of design presentation surface 204 into a bracelet shape. In some examples, one or more adhesive connectors may be employed. In some examples, attachment locations 202 may include complementary portions of connectors (e.g., hook-and-loop connectors, snap or clasp connectors, magnetic connectors, etc.) positioned at respective ends of design presentation surface 204. Regardless of the connector employed, it will be appreciated that the connection formed by the connector may be releasable in some embodiments or may be non-releasable in some other embodiments.

The embodiment of user-wearable memento 110 shown in FIG. 2 also includes a design region 206 where a user-selected design may be applied to design presentation surface 204. In some embodiments, design region 206 may be pre-configured according to one or more design parameters (e.g., size parameters, spacing parameters, design element count parameters, etc.), so that design elements placed within design region 206 are constrained by one or more of the design parameters. In some embodiments, design region 206 may be unconstrained, providing the designer with a figurative blank canvas on which to apply selected design elements.

A designer may specify one or more design elements to be placed within one or more design element locations 208 included in design region 206. User-selected design elements may include designs of a user's own creation (e.g., personal photographs, artwork, etc.), elements created by another user and selected by the user for inclusion in the user-wearable memento, and/or elements selected by some other user for inclusion in the user-wearable memento (e.g., an element selected by the user's friend for inclusion in the memento). For example, in the embodiment shown in FIG. 2, seven design element locations 208 are included in design region 206, though some embodiments may have fewer than seven and some may have more than seven. It will be appreciated that, in some embodiments, one design element may span more than one design location 208, while in some other embodiments, one design location 208 may include portions of more than one design element.

In some embodiments, one or more design elements 206 may include design effects selected by the designer. Including design effects may allow a user to selectively style the visual appearance of one or more design elements and enhance the user design experience. Any suitable design effect may be employed without departing from the scope of the present disclosure. For example, FIG. 3 schematically shows an embodiment of user-wearable memento 300 including horizontal border elements 302 and vertical elements 306 positioned around a plurality design element locations 208. Other suitable design effects may include image filters, background colors and/or textures, and so on.

Turning back to FIG. 2, design region 206 also includes code 112 that represents the set identifier. In some embodiments, code 112 may be included within a code region set apart from design element locations 208 or overlapping one or more design element locations 208. In the embodiment shown in FIG. 2, code 112 includes a human-readable code 212 and a machine-readable code 214. Human-readable code 212 may include any suitable code recognizable by a human; one non-limiting example includes an alphanumeric code. Machine-readable code 214 includes any suitable code recognizable by a machine. Non-limiting examples of machine-readable code 214 include linear codes (e.g., barcodes) and two-dimensional codes (e.g., quick response (QR) codes).

In some embodiments, design region 206 may include a memento identifier 216. Memento identifier 216 identifies each user-wearable memento 110 within a set 108 from all other user-wearable mementos in that set. In an example set 108 consisting of two user-wearable mementos 110, memento identifier 216 may be used to distinguish one user-wearable memento 110 from the other. For example, FIG. 4 schematically depicts an embodiment of a set 108 of user-wearable mementos 110 formed as a single piece. In the embodiment shown in FIG. 4, user-wearable memento 110A includes a memento identifier 216A (depicted as a human-readable tag “WEAR”) different from memento identifier 2168 (“SHARE”) included on user-wearable memento 1108.

Continuing with FIG. 2, design region 206 may also include a design identifier 218 that identifies one or more design elements or an entire design in some embodiments. Thus, design identifier 218 distinguishes one design from another. If included, design identifier 218 may be associated with a design profile related to the design. Further, design identifier 218 may be used to identify promotional opportunities, exclusive content, privileged event access, and other offers associated with the design for delivery to a user via the user communication interface or a third-party interface. If included, designer identifier 218 may include machine-readable and/or human-readable codes or features. In the embodiment shown in FIG. 2, design identifier 218 includes a human-readable code included in the design. Additionally or alternatively, in some embodiments, design identifier 218 may include the design element or the overall design itself.

FIGS. 14-23 show additional embodiments of user-wearable mementos that include aspects similar to the embodiments shown in FIGS. 2 and 3. FIGS. 14-20 depict embodiments of visible, viewable top surfaces user-wearable mementos that include a textured design presentation surface (represented by stippling). If present, such surface texture may result from a textured design presentation surface or a layer underlying a design layer (e.g., a canvas texture visible through an overlying image layer) or from a surface texture resulting from application of the design layer or a surface treatment applied over a design layer (e.g., a textured finish applied over an image layer). FIG. 21 depicts an embodiment of a visible, viewable surface of a user-wearable memento that does not include a visible surface texture. Such an appearance may result from use of a substantially smooth design presentation surface and/or from a smooth finish that results from application of the design or a surface finish applied over the design layer, even if an underlying layer has a native texture.

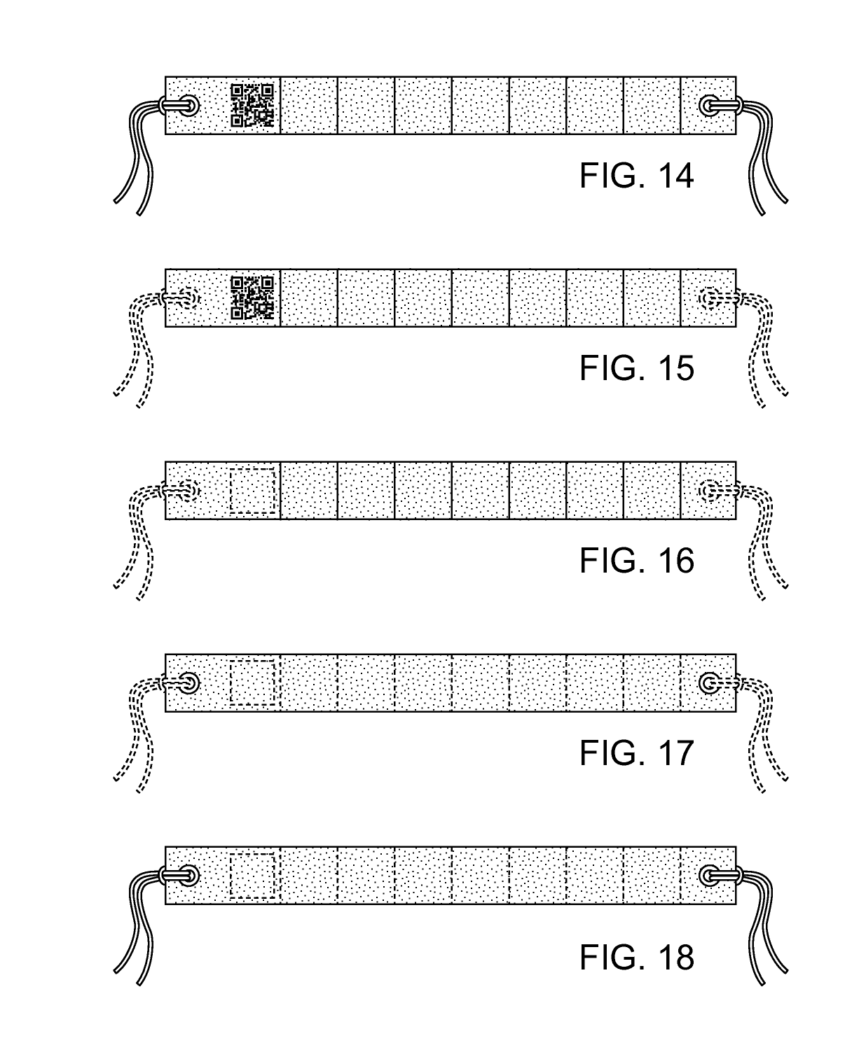

In FIGS. 15, 16, and 23, grommets at attachment points (such as attachment locations 202 shown in FIGS. 2 and 3) are shown in broken lines to illustrate that the grommets do not form a part of the ornamental designs of those embodiments. Similarly, in FIGS. 15-17, 20, and 22, strings at attachment points are shown in broken lines to illustrate that the strings do not form a part of the ornamental designs of those embodiments. Of course any of portions shown in broken lines may be shown in solid, and vice versa, in other embodiments.

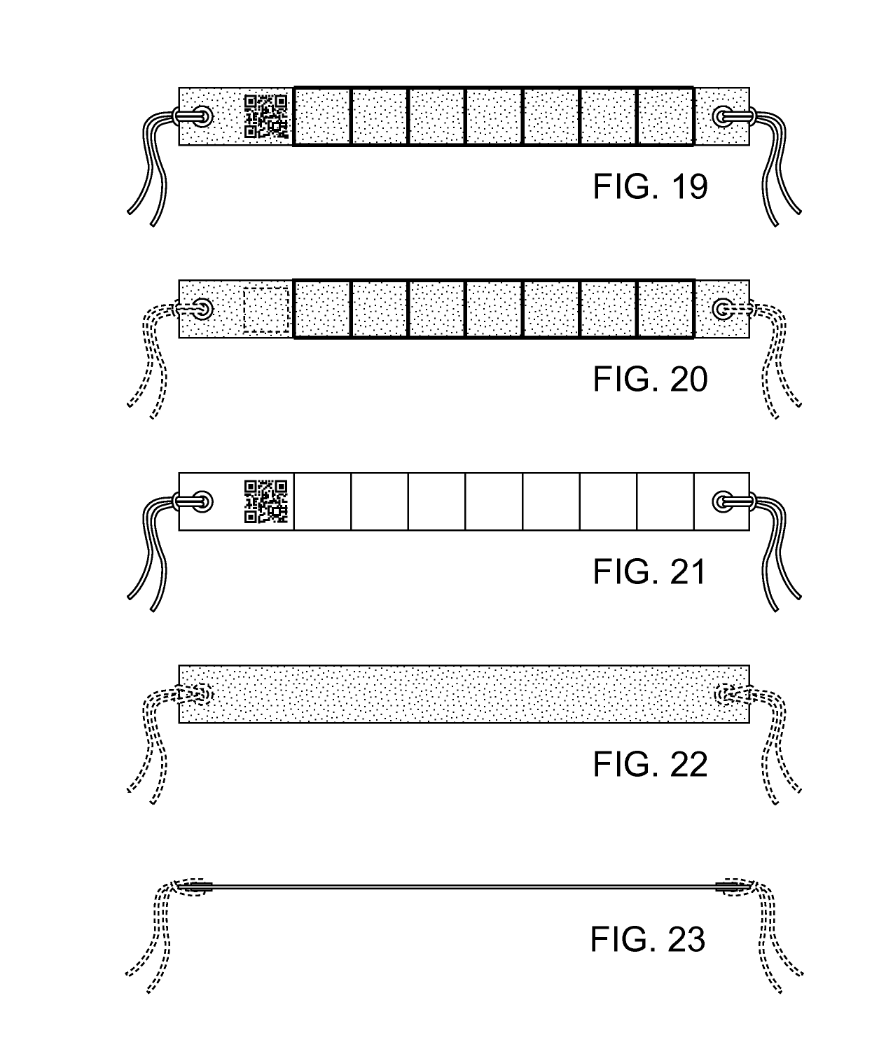

FIGS. 14, 15, 19, and 21 depict embodiments of user-wearable mementos including codes (e.g., QR codes) positioned within a design region, and FIGS. 14-16 and 19-21 depict embodiments of user-wearable mementos including design regions having seven design element locations where design elements may be placed. It will be appreciated that the vertical lines indicating separation between each design element location are provided for illustration purposes only, and may not be visible in some embodiments. In contrast, FIGS. 19 and 20 depict embodiments of user-wearable mementos having borders positioned around each design element location so that each design element will appear separated from a neighboring design element by a visible border.

FIG. 22 depicts an embodiment of a bottom side of a user-wearable memento that is not normally visible when the memento is worn. In the embodiment shown in FIG. 22, the bottom side is depicted as being flat and devoid of surface ornamentation. Of course any suitable design element and/or code may be included on the bottom side in some embodiments, even if hidden from view when worn. For example, a set identifier may be included on the bottom side (as described in more detail below) as may a memento identifier, a design identifier, and/or a design element such as a logo. FIG. 23 depicts a side view of an embodiment of a user-wearable memento.

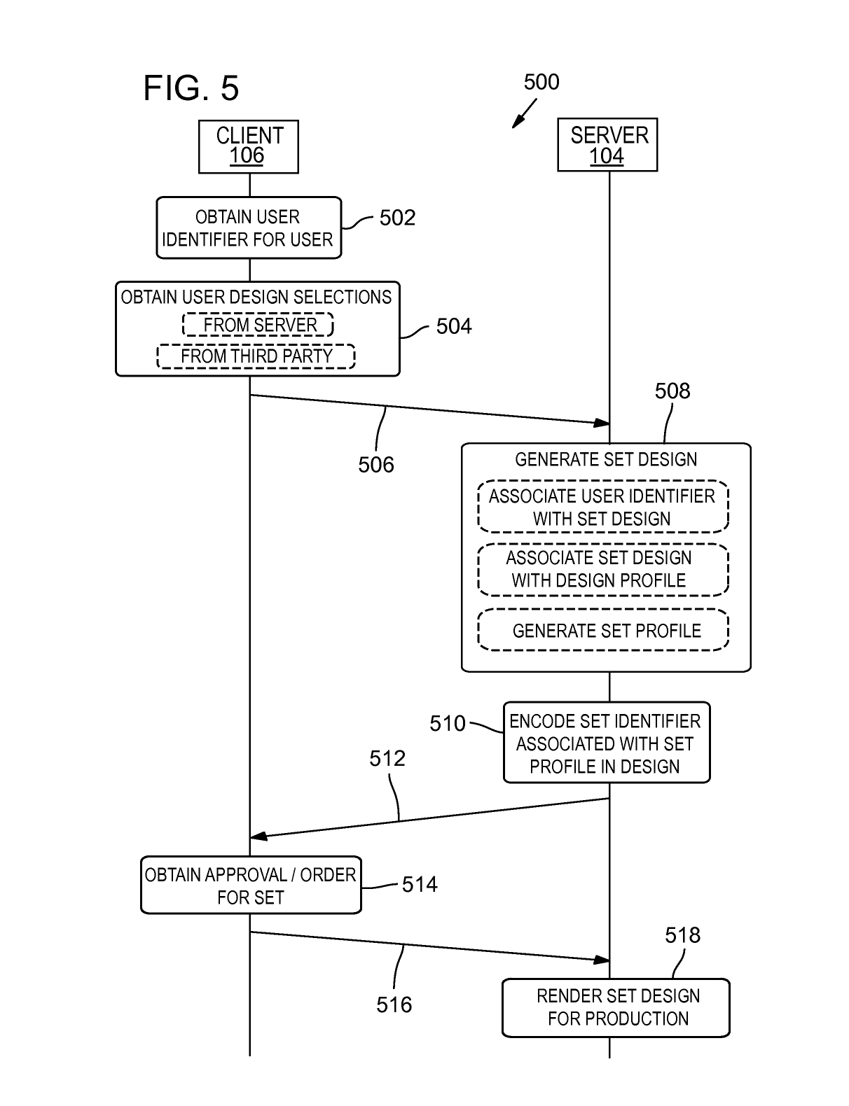

In some settings, a set 108 of user-wearable mementos 110, such the embodiments shown in FIGS. 1 and 4, may be designed and obtained online for easy sharing. FIG. 5 shows a flowchart for an embodiment of a method 500 for obtaining a set of user-wearable mementos, such as those described above. It will be appreciated that the embodiment of method 500 shown in FIG. 5 is provided for illustrative purposes only. In some embodiments, method 500 may be supplemented with a process not shown in FIG. 5, and/or one or more of the processes illustrated in FIG. 5 may be rearranged or omitted without departing from the scope of the present disclosure. Further, it will be appreciated that embodiments of method 500 may be performed by embodiments of the hardware and software described herein. For example, a designer may use an embodiment of client computing device 106 to design and obtain a set of user-wearable mementos using an embodiment of server computing device 104.

Method 500 includes, at 502, obtaining a user identifier for a particular designer at the client computing device. The user identifier distinguishes the designer from other users and links the designer with the memento design, as well as with actions related to memento design generation (e.g., printing, sharing, reviewing, commenting, selecting, etc.). In some embodiments, the user identifier may also link the designer with one or more sets of user-wearable mementos eventually produced from the design.

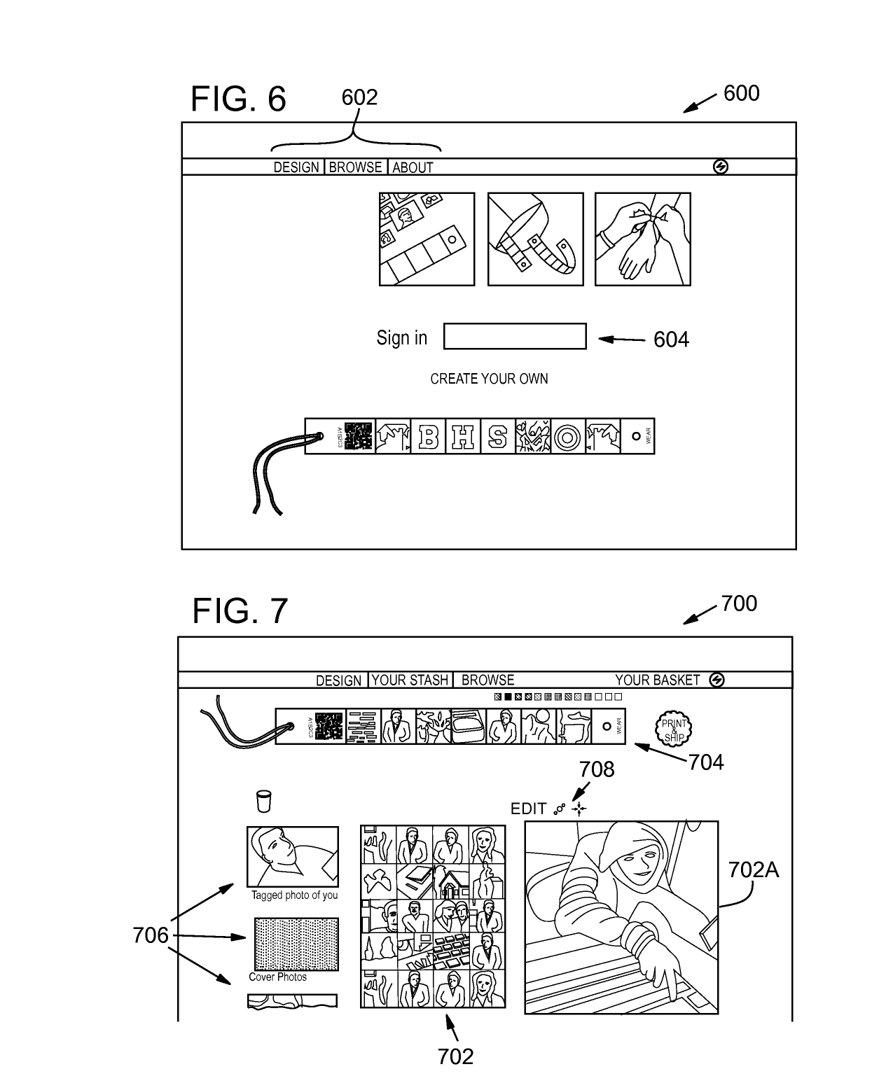

In some embodiments, the user identifier may be obtained when the designer accesses server computing device 104 via client computing device 106. For example, FIG. 6 schematically depicts an embodiment of a login interface 600 including a plurality of navigation controls 602 and a sign-in interface 604. In this example, a sign-in action performed by the designer provides the user identifier to client computing device 106. Additionally or alternatively, in some embodiments, the user identifier may be obtained from a third-party service via a suitable application programming interface (API) when the designer accesses the third-party service. For example, client computing device 106 may obtain the user identifier when the user accesses a third-party social network service or photo-hosting service, subject to user authorization.

Continuing with FIG. 5, at 504, method 500 includes obtaining one or more design selections at client computing device 106. The design element chosen by the designer may include any suitable type or kind of creative expression, such as those described above. Such selections may be obtained in any suitable way. In some embodiments, the selections may be performed by a suitable design interface accessed via client computing device 106.

FIG. 7 schematically shows an embodiment of a design interface 700 that may be used for selecting and creating a memento design. The embodiment of design interface 700 shown in FIG. 7 includes a plurality of design elements 702, any of which may be selected for inclusion in memento design 704. In the embodiment shown in FIG. 7, a palette of design elements 702 is populated from one or more design sources 706. For example, various design elements 702 may be obtained from client computing device 106 (e.g., from a collection held on client computing device 106); from server computing device 104 (e.g., from a collection of server-side images available to the designer), and/or third party computing device (e.g., the designer may select a photograph from the designer's social networking account or photo-sharing account).

Once obtained, one or more design elements 702 may be selected for placement with memento design 704. In the embodiment shown in FIG. 7, design elements 702 selected from the palette may be placed in memento design 704 using a placement control or gesture (e.g., via a click, a click and drag, a drag and drop, etc.). In some embodiments, an individual design element (shown at 702A) may be edited using editing controls 708. For example, the appearance of individual design element 702A may be scaled, filtered, cropped, layered, and otherwise adjusted prior to inclusion in memento design 704.

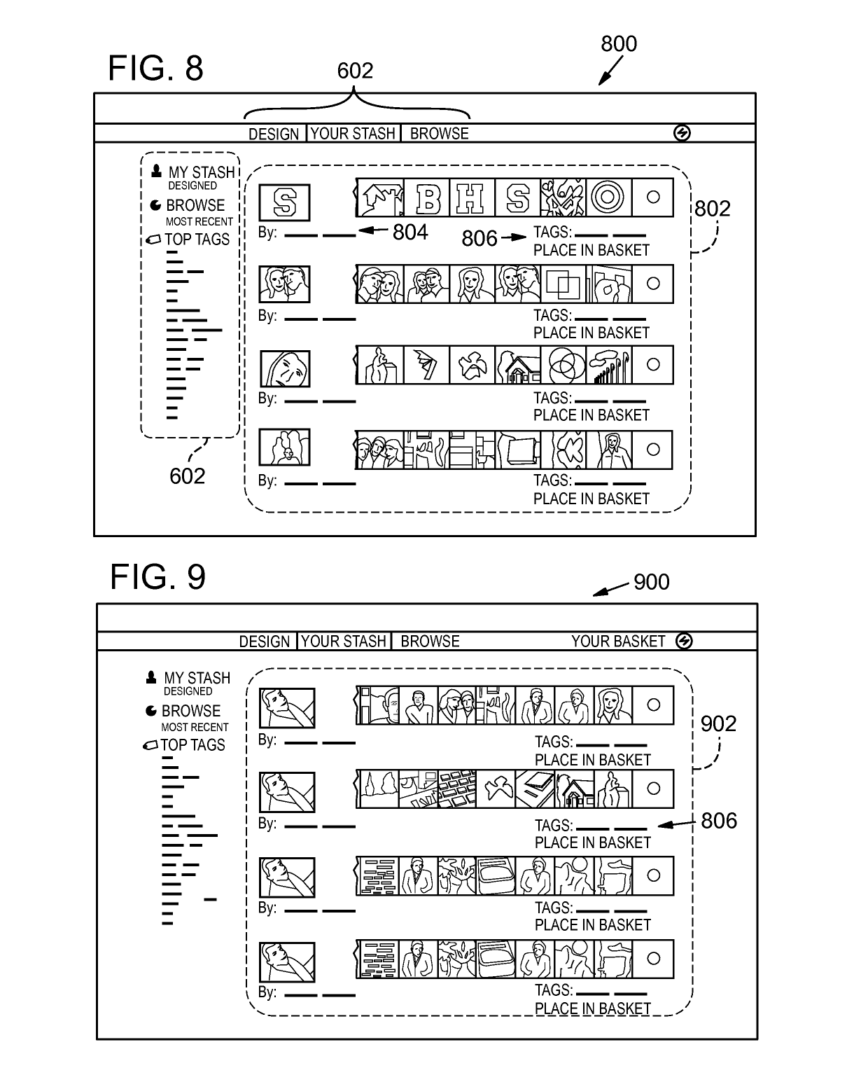

In some embodiments, a designer may select an existing memento design created by another designer. For example, FIG. 8 schematically shows an embodiment of a browser interface 800 displaying a plurality of publicly viewable memento designs 802. Navigation controls 602, in combination with user identifiers 804 and descriptive tags 806 associated with each memento design 802, may help the designer discover other designers' creations. In turn, the designer may select all or part of one or more existing memento designs 802 for inclusion in the designer's own set of user-wearable mementos.

Similarly, in some embodiments a designer may select one or more of that designer's previously created designs for inclusion in the new memento design. For example, FIG. 9 schematically shows an embodiment of a designer profile interface 900. Designer profile interface 900 displays the designer's own memento designs 902 and associated descriptive tags 806. Thus, a designer may re-use a favorite design, modify an existing design, and so on. In some embodiments, designer profile interface 900 may also display other information related to the designer, such as a designer's preferences, friendships, location, reviews and/or comments, and so on. It will be appreciate that, if included, display of any of such information may be selectively enabled subject to designer-selected privacy settings. Further, it will be appreciated that such information may be included in a user's designer profile, which may be selectively shared via a design profile associated with the designer.

Continuing with FIG. 5, once one or more design elements are selected, they are sent to the server computing device at 506, regardless of the type or source for the design elements. At 508, method 500 includes generating a set design for the user-wearable mementos. Generating the set design includes every aspect of transforming the individual designer-selected design elements into a final, complete design for the set, including generating a memento design for mementos included within the set. It will be appreciated that some aspects of generating the set design may be interactive in some embodiments, involving transmissions between server computing device 104 and client computing device 106 not shown in FIG. 5. For example, various aspects of generating the set design may occur via an embodiment of design interface 700, described above. Further, while FIG. 5 depicts set design generation as occurring at server computing device 104, it will be appreciated that any suitable aspect of set design generation may occur elsewhere, such as at a third-party server or at client computing device 106, without departing from the scope of the present disclosure.

In some embodiments, generating the set design at 508 may include associating the user identifier for the designer with the set design. Associating the designer's identity with the set design may allow the designer to keep track of the set design. Further, if permitted by the designer, other users may be able to discover the set design, potentially allowing those users to obtain the design for their own use. The association may be formed in any suitable manner. In some of such embodiments, the designer's user identifier may be associated with the set design using the set identifier for the set.

In some embodiments, generating the set design at 508 may include associating the set design with a design profile. As used herein, a design profile refers to information about the design elements and/or the designer associated with a particular element design, memento design, or set design. In some of such embodiments, a design profile may be associated with the set design by associating a design identifier for the design profile with the set profile and/or with the set identifier. In turn, the design profile may be digitally-linked with the user-wearable memento and accessible via the user communication interface associated with that user-wearable memento.

In some embodiments, one or more privacy settings may be associated with the design profile so that the designer may control others' access to the design profile. Any suitable access control may be employed without departing from the scope of the present disclosure. For example, the designer may configure the design profile to be publicly viewable, viewable by selected users, viewable only by a user in any user set associated with the design, viewable only by a user in a selected user set associated with the design, or viewable only by the designer.

It will be appreciated that any suitable information related to the element, memento, and/or set design may be held in a design profile without departing from the scope of the present disclosure. In some embodiments, a design profile may include memento design information, such as graphical representations of the design elements included in the memento design. For example, memento design information may include one or more photographs included in the memento design.

Memento design information may also include any suitable designer-provided content, such as designer-provided comments about the memento design, a designer-authored story about the design, designer preferences, designer reviews, and designer-provided alerts about upcoming designs and/or special promotions. Further, memento design information may include memento design metadata, such as creation date, creation location, and so on. Similar kinds of information about various design elements and/or the set design may be included in some embodiments of a design profile.

In some embodiments, a design profile may include reviews or comments about the design elements, memento design, and/or set design, and about their designer(s). In some of such embodiments, such reviews or comments may be submitted by other users or viewers of the design profile, even if the viewer or user does not have access to a user-wearable memento.

In some embodiments, a design profile may include information related to the design and/or the designer supplied by a third party, such as another user (e.g., another designer) or a business entity (e.g., a for-profit or a non-profit entity). For example, a design profile may include special offers, promotional opportunities to purchase a particular designer's merchandise and/or to receive discounts for including a design element created by a particular designer in another design, and so on. Such offers may be in the form of push-notifications delivered to a user when the user views the design profile. For example, one designer may receive a special offer to buy a design element created by another design for inclusion in a set of user-wearable mementos.

It may be difficult to protect confidential information belonging to the users in one user set when more than one set of mementos shares a common design. For example, users in one user set may want to have mementos that exhibit a popular, publicly available design (e.g., a design from a popular charity or artist). However, because all of the sets sharing that design may have access to the same design profile, some users may wish to shield some information from users not in their user set. Accordingly, in some embodiments, a separate set profile specific to a particular set of user-wearable mementos may help keep information belonging to the user set associated with that set confidential. Unlike a design profile, information in a set profile is only accessible to a user within a user set associated with the set profile, as verified by a user-wearable memento associated with that user set.

Accordingly, in some embodiments, generating a set design at 508 may include generating a set profile for the design. As used herein, a set profile refers to information about a particular set of user-wearable mementos bearing the selected design. The set profile is associated with the particular set via the set identifier so that the set profile may be digitally-linked with the user-wearable memento. In turn, the set profile may be accessed via the user communication interface associated with that user-wearable memento. Thus, even if two or more sets of user-wearable mementos have a common design, a user will only be able to access the set profile associated with the set identifier borne by that user's memento.

It will be appreciated that any suitable user-specific information and/or set-specific information may be held in a set profile without departing from the scope of the present disclosure. Non-limiting examples of user-specific information include confidential messages shared between users (e.g., messages submitted by users via chat sessions and/or message board functions); users' personally identifiable information (e.g., user name information, user location information, etc.); information about users' activity at third-party services (e.g., a social networking service, a photo-sharing service, etc.); and possession information related to sharing or exchanging user-wearable mementos in the set with others. Non-limiting examples of set-specific information include set metadata such as set identifier information, memento identifier information, and so on. Accordingly, a set profile may include any information helpful for forming and maintaining relationships among users through use and maintenance of the associated set of user-wearable mementos.

In some embodiments, various aspects of user-specific information included in the set profile may be subject to user-selected privacy settings. If included, such privacy settings may add to the security provided by the user-wearable memento. In some of such embodiments, such privacy settings may be secured via a user-selected password or code kept separate from the user-wearable memento.

At 510, method 500 includes encoding the set identifier associated with the set profile within the memento design. Further, in some embodiments, a memento identifier and/or a design identifier may be encoded within the memento design. It will be appreciated that the set identifier, memento identifier, and/or the design identifier may be encoded in any suitable way and in any suitable position within the design. In some embodiments, encoding the identifier(s) within the design may include generating a suitable machine-readable code and/or a human-readable code and placing the code(s) within the memento design. For example, a QR code or an alphanumeric code encoding a URL associated with a set of user-wearable mementos may be generated and placed within the design. In some embodiments, a single code may include a plurality of identifiers (e.g., a set identifier and a memento identifier, a set identifier and a design identifier, a memento identifier and a design identifier, and a set identifier, a memento identifier, and a design identifier).

As used herein, placing a code within a design or encoding an identifier within a design refers to including a suitable machine-readable and/or human-readable code or a suitable machine-readable and/or human-readable identifier on a visible, viewable surface of a user-wearable memento so that a human and/or a machine observer may view the code and/or identifier while the memento is in use. In one scenario, a code may be configured to be publicly viewable when in use, potentially allowing easy access to the code. In another scenario, a code may be configured to be shielded from public view when in use, potentially allowing a wearer to selectively control access to the code. For example, a code included in a friendship bracelet may be included in a backside design so that the code is normally shielded from view until exposed (e.g., by flipping over).

In some embodiments, a code or identifier may be included within a design presentation surface of the user-wearable memento. For example, a code or identifier may be included in a code region positioned within or proximal to a memento design region of the design presentation surface. In some embodiments, a code or identifier may be included in one or more design elements, in a viewable region underlying one or more design elements, or in a viewable region overlying one or more design elements. For example, one or more characteristics (e.g., line shapes, color values, image contrast values, etc.) of one or more design elements may be used as a code or to encode an identifier.

At 512, method 500 includes sending the set design to client computing device 106 for review, and, at 514, obtaining approval for the design. In some embodiments, the designer may selectively approve various aspects of the design. For example, the designer may selectively approve one or more of the memento design, one or more individual design elements, a title for the design, privacy settings for the design, a story about the design, and a method for tracking mementos that may be produced from the memento design. In some embodiments, a designer may elect to share approved designs publicly, with other selected users, and/or with other selected users of a third-party service, such as a social networking service or photo-sharing service.

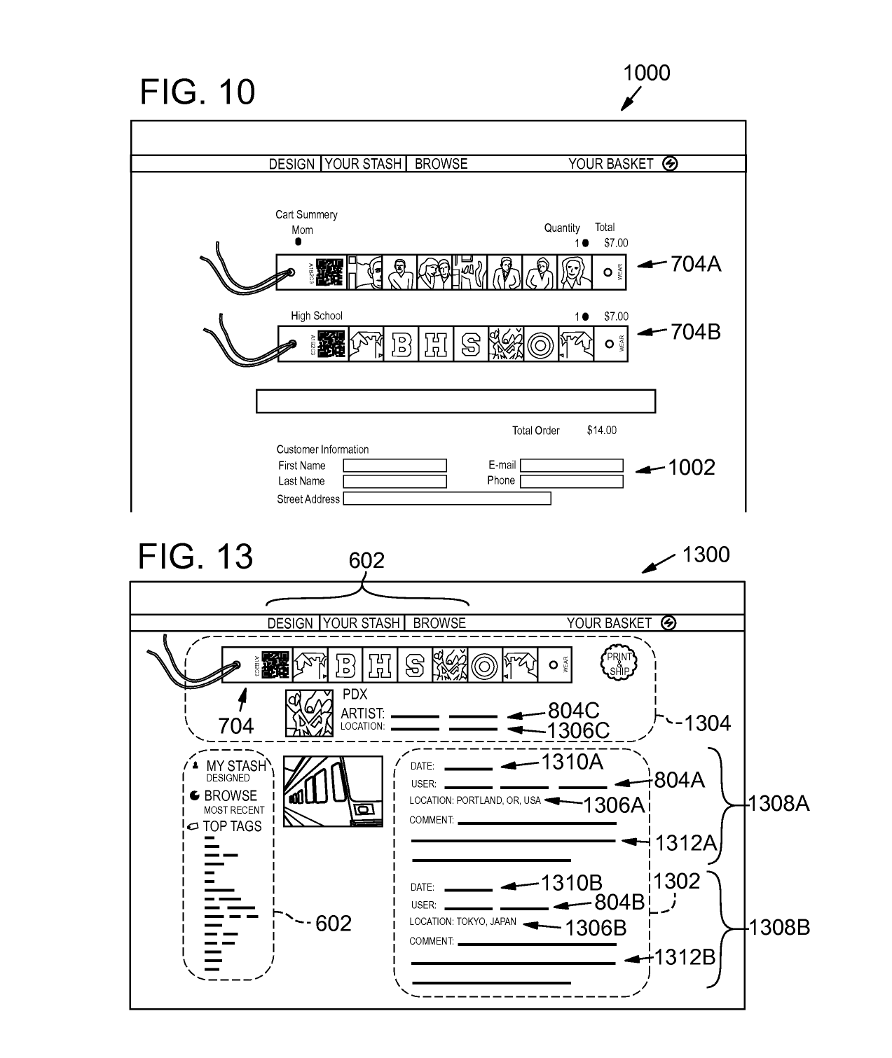

Any suitable manner of obtaining the designer's approval may be employed without departing from the scope of the present disclosure. In some embodiments, a designer may approve a design by placing the design in a shopping cart and order the set via a cart checkout process. FIG. 10 schematically shows an embodiment of a cart checkout interface 1000. In the example shown in FIG. 10, cart checkout interface 1000 displays two memento designs, shown at 702A and 702B, approved and ordered by a designer. Cart checkout interface also includes a user information interface 1002 where a designer may enter payment, address, delivery, other information related to ordering and obtaining the selected sets. Once ordered, method 500 includes sending the design for production at 516.

Continuing with FIG. 5, at 518, method 500 includes rendering the memento design into a production-ready set design for fabrication. In some embodiments, rendering the memento design into a set design may include preparing the memento design for fabrication as a user-separable product. For example, a design element may be added or modified to the memento design when rendering the set design.

A set design includes all of the design elements included in a particular set 108. For example, a set design may include one or more separation regions indicating where one or more user-wearable mementos may be separated from one another and/or from a carrier material. In the embodiment shown in FIG. 4, for example, set 108 has a set design 402 that includes a plurality of memento designs 404 included in memento regions 406. In some embodiments, a common memento design 404 may be included in each memento region 406, while different memento designs 404 may be included in memento regions 406 in some other embodiments. The embodiment of set design 402 shown in FIG. 4 also includes a plurality of memento identifiers 408 and a separation marker 410 positioned in a separation region 412 of set 108. Separation marker 410 indicates a separation location where the user-wearable mementos 110A and 1108 may be separated from one another.

In some embodiments, the memento regions included in a set design may be spaced apart from one another on more than one side by respective separation regions. For example, a set design may include a design for a sheet of a carrier material from which a plurality of spaced-apart mementos positioned side-by-side may be removed (e.g., by punch-out, peel off, tear-off, etc.) after production.

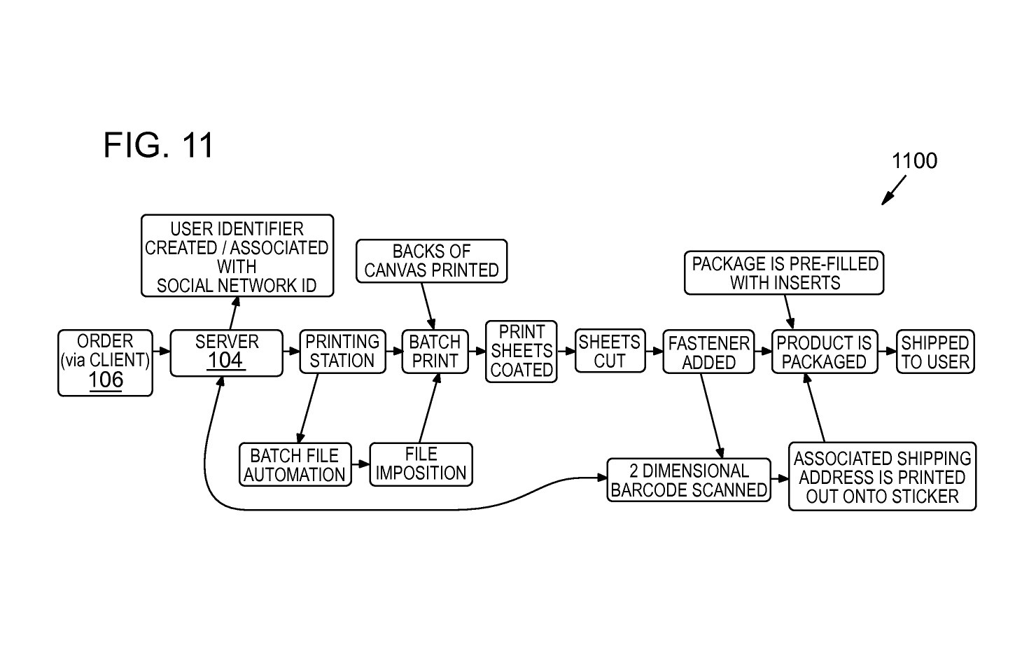

The user-wearable tokens may be fabricated after rendering the set design. For example, FIG. 11 shows a flowchart for an embodiment of a method 1100 of fabricating a set of user-wearable mementos. In the embodiment shown in FIG. 11, a set design ordered by a user with an embodiment of method 500, for example, is printed on photo-quality canvas substrate, trimmed to shape and supplied with fasteners, and packaged for shipment to the user. For example, a user ordering a set of two photo-bracelets causes the set to be printed and shipped to the user. The set may be shipped as individual bracelets, as one or more carrier sheets holding a plurality of bracelets, or as a single strip including a pair of bracelets for later separation by the user. In this example, the bracelets have a common memento design, including a common set identifier encoded therein. However, the bracelets also have different memento identifiers to distinguish them, one being identified as WEAR and the other as SHARE. The user may give the SHARE bracelet to a friend and wear the other as a friendship bracelet.

In some embodiments, a set of user-wearable mementos may be created on demand. For example, a set design may be created on-site at an event venue (e.g., a fundraiser, concert, amusement park, etc.) using design elements obtained at the venue and/or via access to online sources. Once created, the set design may be printed at the venue (e.g., at a production kiosk) and distributed to the recipient. The recipient may then use the user-wearable memento as a souvenir and also to gain access to event locations, pay for event services and/or bid on auction items (e.g., via a credit or debit card service linked to the user-wearable memento), track event experiences, keep track of people encountered at the event (e.g., via the user communication interface and/or a social networking service linked to the user-wearable memento), and receive future promotional offers related to the event (e.g., via a promotional or other commercial service linked to the user-wearable memento).

Because the bracelets in the example above are also digitally linked via the set profile associated with the two bracelets in the set, these friends may keep in touch with one another via secure communication system 102, using the user communication interface 114 to connect with one another online, trade confidential messages with one another, and/or update bracelet associations when passing one or both of the bracelets along to other people.

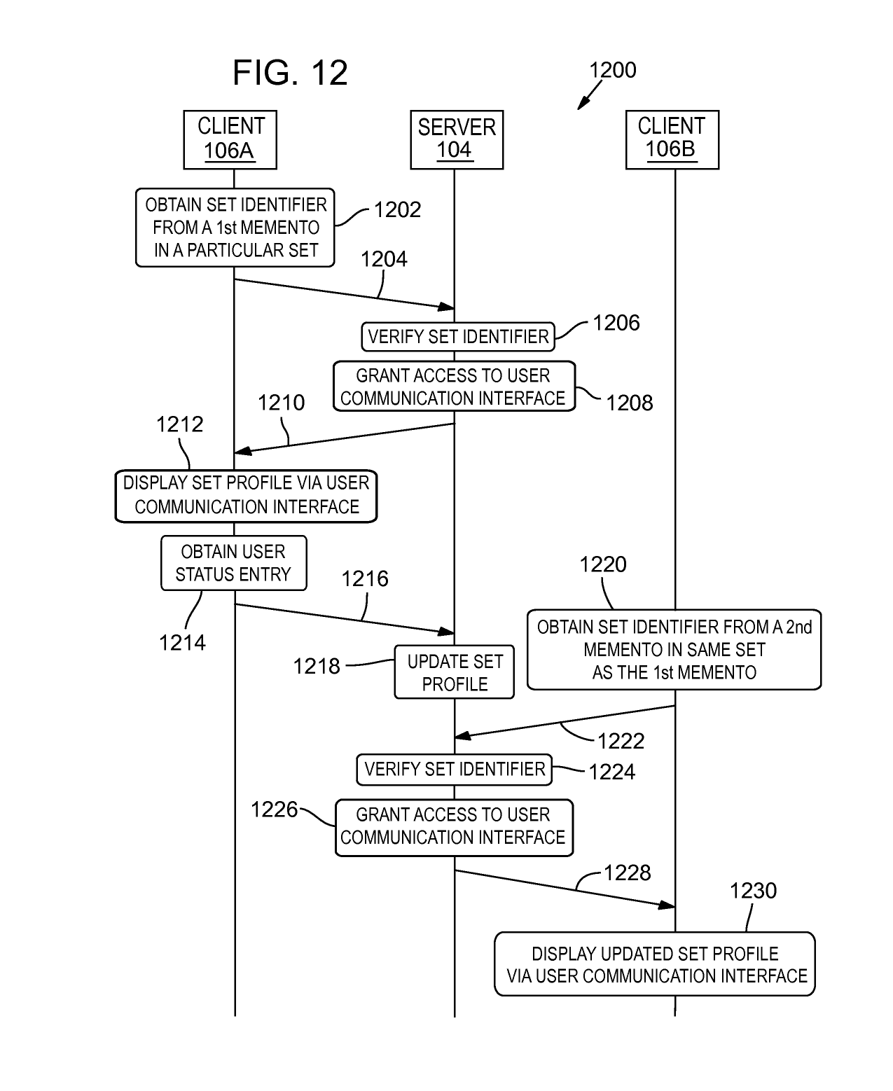

FIG. 12 shows a flowchart for an embodiment of a method 1200 of communicating via a secure communication system. It will be appreciated that the embodiment of method 1200 shown in FIG. 12 is provided for illustrative purposes only. In some embodiments, method 1200 may be supplemented with a process not shown in FIG. 12, and/or one or more of the processes illustrated in FIG. 12 may be rearranged or omitted without departing from the scope of the present disclosure. In some embodiments, method 1200 may employ embodiments of the hardware and/or software described herein.

Method 1200 includes, at 1202, obtaining a set identifier from a user-wearable memento included in a set of user-wearable mementos at client computing device 106A. The set identifier may be obtained in any suitable way. Non-limiting examples include code capture using an optical input device such as a camera or scanner and user input device such as a touch input device or keyboard. For example, a code reader on a mobile phone may be used to scan a set identifier encoded as a URL for a set-specific user communication interface.

At 1204, method 1200 includes sending a request to access a set profile including one or more user status entries associated with the set from client computing device 106A to server computing device 104. Continuing with the example scenario above, the mobile phone may send the URL/set identifier obtained from the memento to a server as a part of an access request for a user communication interface.

In some embodiments, the access request may include a user identifier, a design identifier, and/or a memento identifier. For example, the access request may include a user identifier obtained from user login information, a design identifier may be obtained from scanning the memento design, and a memento identifier may be obtained from a user input. If included, such identifiers may be associated with various user-supplied actions and/or entries to distinguish the actions of individual users as linked to individual mementos.

At 1206, method 1200 includes, at server computing device 104, verifying the set identifier included in the request to access the set profile. Only the set identifier associated with and encoded in the design for the set of user-wearable mementos will be verified. Verification may be obtained in any suitable way. In some embodiments, the set identifier may self-identify. For example, a URL encoded in the set identifier may link to a set-specific user communication interface. In some embodiments, verification may include a suitable password, keyed access, or other encryption scheme tied to the set identifier. In some embodiments, verification may include location information (e.g., a location-based verification scheme) used to affirm identity and/or to detect fraudulent and/or invalid access attempts. Upon verification, method 1200 includes granting access to a user communication interface at 1208.

Once access to the user communication interface is granted, client computing device 106A may access secure information related to the particular set of user-wearable mementos associated with the set identifier. In some embodiments, client computing device 106A may access information secured in the set profile associated with the set identifier. Thus, at 1210, method 1200 includes the server computing device 104 sending information included in a set profile associated with the set of user-wearable mementos to client computing device 106A.

In some embodiments, client computing device 106A may also have access to design profile information for the set. Thus, in some of such embodiments, method 1200 may include sending information included in a design profile associated with the memento design from server computing device 104 to client computing device 106.

At 1212, method 1200 includes, at client computing device 106, displaying at least a portion of the information included in the set profile via an instance of the user communication interface. In some embodiments where information included in a design profile is sent to client computing device 106A, displaying a portion of the information included in the set profile at 1212 may also include displaying a portion of the information included in the design profile.

For example, FIG. 13 schematically shows an embodiment of a user communication interface 1300. In the embodiment shown in FIG. 13, user interface 1300 includes set profile display 1302 of information included in a set profile for the associated set and a design profile display 1304 of information included in a design profile for the associated set. Set profile display 1302 may include any suitable information included in the set profile associated with the set of user-wearable mementos. In the example shown in FIG. 13, date information, location information, and comment information is viewable using set profile display 1302.

If included, design profile display 1304 may include any suitable design-related information included in the design profile associated with the set design. In the example shown in FIG. 13, design profile display 1304 includes a graphical representation of the memento design 704, designer information (shown as a user identifier 804C for the designer), and location information (shown as location information 1306C). In some embodiments, various special offers may also be presented via design profile display 1304, such as announcements featuring new designs from the designer, discounts on designs from the designer, co-branded merchandise from the designer, and so on.

At 1214, method 1200 includes obtaining a user status entry at client computing device 106A, and, at 1216, sending the user status entry to server computing device 104. As used herein, a user status entry refers to information about a user provided to the set profile. Non-limiting examples of information that may be included in a user status entry include user location information; user messages, comments, indications of approval and/or disapproval, and reviews; user-wearable memento possession information; and user-submitted content (e.g., photographs, images, stories, etc.). User status entries may be submitted in any suitable way by any party or device having access to the set profile. For example, user status entries may be user-submitted, submitted by the user's device, and/or by another user within the user set.

In some embodiments, a user status entry may include a user identifier, a design identifier, and/or a memento identifier. If included, such identifiers may be associated with the user status entry. Associating such identifiers with the user status entry may help identify user status entries originating from different users and track changes in location and/or user-wearable memento possession. For example, in a scenario where a user acquires a user-wearable memento, a user may include a user identifier and a memento identifier with a user access status entry so that the user's identifier will be associated with the memento identifier. In turn, the set profile may be updated to reflect the user's possession of that user-wearable memento.

Receipt of the user status entry results in an update to the set profile, so that the set profile includes the information submitted via the user status entry. At 1218, method 1200 includes updating the set profile with the information included in the user status entry. For example, FIG. 13 depicts a plurality of user status entries, shown as 1308A and 13088. Each of the user status entries shown in FIG. 13 includes date information (shown as 1310A and 1310B, user identifier information (shown as 804A and 804B), location information (shown as 1306A and 1306B), and a user-submitted comment (shown as 1312A and 1312B). As another example, receipt of a user access status entry may lead to a change in the ability for that user to access the set profile. For example, a newly-associated user identifier may be granted access to the set profile and a formerly-associated user identifier may be prevented from accessing the set profile. Thus, receipt of a user access status entry may update the set profile to reflect an association of a different user identifier with the memento identifier.

At 1220, method 1200 includes, at client computing device 106B, obtaining a set identifier from a second user-wearable memento included in the same set of user-wearable mementos, and at 1222, sending a request to access the set profile associated with the set from client computing device 1068 to server computing device 104. It will be appreciated that any suitable method of obtaining a set identifier may be employed, including, but not limited to, the methods described above.

At 1224, method 1200 includes, at server computing device 104, verifying the set identifier included in the request to access the set profile, and, at 1226, granting access to the user communication interface associated with the set. It will be appreciated that any suitable method of verifying access may be employed, including, but not limited to, the methods described above.

At 1228, method 1200 includes sending information included in the updated set profile from server computing device 104 to client computing device 106B, and at 1230, displaying at least a portion of the information included in the updated set profile via an instance of the user communication interface at client computing device 1068. For example, one user-submitted message (for example, user status entry 1308A in FIG. 13) submitted by a first user may be viewed by another user via the user communication interface on that user's client device. That user may submit a reply message (for example, user status entry 1308B in FIG. 13) in response to the first user's message. The first user may then view the reply message via the user communication interface using the first user's client device, and continue the conversation by posting another message.

It will be appreciated that secure communication system 102 may employ any suitable hardware and software. For example, FIG. 1 depicts server computing device 104 in network communication with a plurality of client computing devices 106. Client computing devices 106 may include any suitable computing device. Non-limiting examples of client computing device 106 include mobile devices (e.g., mobile phones, smartphones, tablets, electronic readers, laptops, etc.), desktop computing devices, network-connected entertainment devices (e.g., televisions, game consoles, etc.), kiosk-based computing devices, and so on. Likewise, server computing device 104 may include any suitable computing device. Non-limiting examples include servers, cloud-computing devices, mainframes, and so on. Optionally, one or more of client computing devices 106 and server computing device 104 may include one or more suitable user input devices used to receive input from a user. Non-limiting examples of such user input devices include touch screens, keyboards, mice, remote and/or game controllers, and so on.

In the embodiment shown in FIG. 1, server computing device 104 includes a data subsystem 130 and a processing subsystem 132. Data subsystem 130 holds non-transitory instructions executable by a processing subsystem 132 to perform one or more of the methods described herein. Any suitable data subsystem may be employed without departing from the scope of the present disclosure. Non-limiting examples of data subsystem 130 include suitable memory devices (e.g., optical, magnetic, and/or semiconductor memory devices) that may be used to hold non-transitory instructions. In some embodiments, data subsystem 130 may include a database configured to hold instructions and/or data for processing using processing subsystem 132.

Processing subsystem 132 executes instructions and processes data held in data subsystem 130 when performing one or more of the methods described herein. Processing subsystem 132 may include one or more processing devices (e.g., semiconductor logic devices) configured to receive instructions, process data according to the instructions, and store the result of such processes in data subsystem 130, so that different data is held in data subsystem 130 after execution.

In some embodiments, instructions and/or data may be shared with server computing device 104 using a suitable computer-readable storage medium 134 (e.g., a suitable optical, magnetic, and/or semiconductor memory storage medium) may be used to hold and/or transport instructions and/or data. Further, in some embodiments, server computing device 104 may share data and/or instructions with a suitable database (e.g., another server computing device, a cloud computing environment, etc.) in network communication with server computing device 104.

It will be obvious to those having skill in the art that many changes may be made to the details of the above-described embodiments without departing from the underlying principles of the invention. The scope of the present invention should, therefore, be determined only by the following claims.

1. A computing system for securing communication between users possessing user-wearable mementos, the computing system comprising:
a processing subsystem; and
a data subsystem holding instructions executable by the processing subsystem to:
in response to receipt of a request to obtain a set of the user-wearable mementos having a user-selected design, (1) assign a set identifier to the set that uniquely distinguishes the set from any other set, the set identifier being the same for each user-wearable memento within the set, and (2) encode the set identifier within the user-selected design; and
in response to a request to access a set profile including one or more user status entries associated with the set, provide access to a user communication interface, the request to access the set profile including the set identifier assigned to the set as obtained from a particular user-wearable memento bearing the user-selected design.

2. The computing system of claim 1, further comprising instructions to send the set profile for display via the user communication interface.

3. The computing system of claim 1, further comprising instructions to:
update the set profile for the set in response to receipt of a user status entry for the set via the user communication interface; and
send an updated set profile for display via the user communication interface in response to receipt of another access request including the set identifier.

4. The computing system of claim 1, where the one or more user status entries include one or more of a user-supplied location entry and a user-supplied communication entry provided by a user associated with one of the user-wearable mementos included in the set.

5. The computing system of claim 1, further comprising instructions to send a design profile for display via the user communication interface, the design profile including design information associated with the user-selected design.

6. The computing system of claim 1, further comprising instructions to:
assign a memento identifier to a particular user-wearable memento within the set, the memento identifier distinguishing the particular user-wearable memento from any other user-wearable memento included in the set;
assign a user identifier to a particular user, the user identifier distinguishing the particular user from any other user; and
associate the user identifier with the memento identifier.

7. The computing system of claim 6, further comprising instructions to associate a different user identifier with the memento identifier in response to a request to update a user access status for the particular user-wearable memento.

8. The computing system of claim 1, further comprising instructions to:
generate a set design including the user-selected design and a machine-readable code for the set identifier; and
send the set design including the user-selected design for production as a memento-including product.

9. The computing system of claim 8, where the set design includes at least two memento regions separated from one another by a memento separation region where the at least two memento regions are separable from one another, each memento region including an identical user-selected design and an identical machine-readable code.

10. The computing system of claim 8, where the set design includes one or more of a memento identifier that distinguishes the particular user-wearable memento from any other user-wearable memento included in the set, a design identifier that identifies a design element included in the user-selected design, and a separation marker.

11. The computing system of claim 1, where the request to access the set profile includes a memento identifier that distinguishes the particular user-wearable memento from any other user-wearable memento included in the set.

12. A method of securing communication between users using a user communication interface associated with a set of user-wearable mementos, the user-wearable mementos within the set each bearing a common set identifier that uniquely distinguishes the set from any other set, the method comprising, at a server computing device:
receiving a first user communication interface access request from a first client device, the first user communication interface access request including the set identifier as obtained from a first user-wearable memento included in the set;
providing the first client with access to the user communication interface in response to the first user communication interface access request;
receiving a user status update from the first client device;
including the user status update in a set profile associated with the set;
receiving a second user communication interface access request from a second client device, the second user communication interface access request including the set identifier as obtained from a second user-wearable memento included in the set; and
in response to the second user communication access request:
providing the second client with access to the user communication interface, and
sending the set profile with the user status update to the second client for display via the user communication interface.

13. The method of claim 12, where the user status entry includes one or more of a location entry and a communication entry for a user associated with the first user-wearable memento.

14. The method of claim 12, further comprising sending a design profile via the user communication interface in response to the second user communication access request, the design profile including design information associated with a user-selected memento design.

15. The method of claim 12, further comprising:
assigning user identifiers to both the first user and the second user so that the first user and the second user may be distinguished from one another;
associating the first and second user-wearable mementos with the respective first and second user identifiers; and
changing the user identifier associated with a particular memento in response to a change in user access status for the particular memento.

16. The method of claim 12, further comprising, in response to a request to obtain the set of user-wearable mementos:
generating a set design including a machine-readable code for the set identifier; and
sending the set design for production as memento-including product.

17. The method of claim 16, where the set design includes at least two memento regions separated from one another by a memento separation region where the at least two memento regions are separable from one another, each memento including a common user-selected design and a common machine-readable code.

18. The method of claim 16, where generating the set design further comprises including one or more of a memento identifier, a design identifier, and a separation marker in the set design.

19. The method of claim 12, where the first user communication interface access request includes a memento identifier that distinguishes the first user-wearable memento from the second user-wearable memento.
